(19) United States
(12) Patent Application Publication
(10) Pub. No.: US 2007/0297309 A1
(43) Pub. Date: Dec. 27, 2007

(54) Optical disc recording method and optical disc recording apparatus

(75) Inventors: Takakiyo Yasukawa, Fujisawa (JP); Koichi Watanabe, Hachioji (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 11/729,739

(22) Filed: Mar. 28, 2007

(30) Foreign Application Priority Data
Jun. 23, 2006 (JP) 2006-173292

(51) Int. Cl. G11B 20/10

(52) U.S. Cl. 369/59.11

(57) ABSTRACT

An optical disc apparatus that ensures a stable recording performance by assigning a separate recording power to a driving current for driving a laser during recording in response to each record length.

### INCORPORATION BY REFERENCE

The present application claims priority from Japanese application JP2006-173292 filed on Jun. 23, 2006, the content of which is hereby incorporated by reference into this application.

### BACKGROUND OF THE INVENTION

The present invention relates to a method and apparatus for recording information on an information recording medium through the use of a laser.

Conventionally, a multi-pulse type (pulse train) waveform (strategy) has been used as a laser driving current when recording information on an optical disc. (refer to FIG. 18 of a Japanese Laid-open Patent Application JP-A-2003-85753).

However, as recording has become increasingly faster in recent years, there arises a problem with the above waveform as described in the JP-A-2003-85753. The description reads as follows: “The above write strategy, which is satisfactory during normal speed recording, experiences a problem that makes it difficult to control the recording pulse for driving the recording laser since a clock runs faster during high-speed recording. During the high-speed recording, the clock for generating the recording pulse runs faster by itself. Accordingly, the cycle of each pulse 91 that constitutes the pulse train 92 becomes shorter, and thereby each pulse 91 gets closer to each other. Therefore, a rise time of the recording laser becomes relatively longer with respect to the clock in the part of each pulse 91 constituting the pulse train 92, thus the recording pulse resulting in a waveform in which each pulse 91 constituting the pulse train 92 is actually connected together. Thus, it becomes difficult to control the amount of heat that is applied to the optical disc by irradiating a laser during recording.”

Therefore, a castle type strategy has come to be used in order to solve the foregoing problem. The castle type strategy is also used in the above JP-A-2003-85753 to solve the foregoing problem. The description of the JP-A-2003-85753 runs as follows: “According to the present invention, the recording pulse comprises a top pulse, an intermediate bias part and a last pulse, or comprises the top pulse and intermediate bias part, and does not include a part in which a plurality of small-width pulses are continuous like a pulse train in the conventional write strategy. Accordingly, even if the clock for high-speed recording runs faster, it is possible to reduce the influence that a rise and a fall, and an overshoot and an undershoot in a recording pulse waveform have on the recording mark.” (refer to FIG. 5 in JP-A-2003-85753)

### SUMMARY OF THE INVENTION

First, a conventional example of the multi-pulse type strategy and a conventional example of the castle-type strategy will be described with reference to FIGS. 11 and 12, respectively.

FIG. 11 shows the multi-pulse type strategy in which a recording power (Pw) and a bias power (Pb) are alternately switched to form a record mark. An assist power (Ps) is supplied to a space part in order to efficiently provide the energy of the recording power. The assist power equivalent to the bias power may be supplied depending on the material of a recording medium. In the case of a rewritable recording medium, a laser power called as an erasing power for converting the recording medium back into to the same state as an unrecorded state is supplied instead of the assist power (Ps). As a pattern of the write strategy, one pulse is used for forming shortest 2T, two pulses are used for forming 3T, and a pulse of 1T cycle is added for forming 3T or more according to the length of the mark. Laser power is reduced from the recording power to bias power at the end of the mark, thus adjustment being made by interrupting heat.

The castle type strategy shown in FIG. 12 is not a recording pulse that falls in 1T cycle like the multi-pulse type strategy, and the shape of a basic recording pulse is nearly a rectangular wave. While one pulse is used for forming the mark length of 2T or less in the case of the multi-pulse type strategy, one pulse is used for forming the mark length of 3T or less in the case of the castle type strategy. While 4T is not shown here for the sake of simplicity, when the mark length is 4T or more, Pm of an intermediate power is set in the center of the recording pulse.

Due to the development of a next-generation optical disc, as represented by a BD (Blu-ray disc) or the like of these days, the length of a shortest mark to be recorded has become shorter than that of a conventional DVD (Digital Versatile Disc) or the like, and the recording density has become higher. Specifically, the shortest mark length for the BD has shortened to 0.15 μm against 0.42 μm of the DVD. Moreover, while a semiconductor leaser with a wavelength of 650 nm range and an objective lens with a numerical aperture of 0.60 NA are used in a DVD optical system, a semiconductor leaser with a wavelength of 405 nm range and an objective lens with a numerical aperture of 0.85 NA are used in a BD optical system.

When recording is performed on such a high-density recording medium as described in the above, the strategy is required to be used at the same timing (on time axis) as high-speed recording in the conventional DVD even during low-speed recording. Furthermore, when performing high-speed recording on the high-density recording medium in the future, not only the timing on time axis but also power must be controlled. In other words, this means that in order to obtain a satisfactory recording quality during the high-speed recording on the high-density recording medium, precise power control of the y-axis must be conducted in addition to the timing control of the x-axis (time axis) in the examples shown in FIGS. 11 and 12. The reason is as follows: When information is recorded on an optical disc, a recording film must be thermally changed, and when high-speed recording is performed on the high density medium, high power must be applied in a relatively short time compared with during conventional recording. Otherwise, a desired thermal change will not be achieved, resulting in poor recording quality.

However, in the conventional technology represented by the above JP-A-2003-85753 or the like, there is no disclosure about a technology for controlling the recording power in response to the speedup of recording and higher recording density (shortening the length of the mark to be recorded).

Therefore, it is an object of the present invention to provide an optical disc recording method and optical disc recording apparatus capable of solving the foregoing problems and of achieving satisfactory recording quality even during the high-speed recording performed on a high density medium.

For example, the following embodiments are capable of solving the foregoing problems. However, there is no limitation thereto.

The above object can be achieved by, for example, following embodiment: An optical disc apparatus for forming a mark to record information on an optical disc. The optical disc apparatus comprises a light-emitting part for emitting a laser beam; an emission waveform generating part for generating the emission waveform of the light-emitting part; and a control part for controlling the emission waveform generating part. More specifically, the control part controls the emission waveform generating part such that it changes the light-emitting power of the emission waveform according to the length of the mark.

Furthermore, the above object can also be achieved by the following embodiment: an optical disc recording method for emitting a laser beam from the light emitting part to form a mark and record information on the optical disc. More specifically, the height of the pulse of the emission waveform of the laser beam is changed according to the length of the mark.

The present invention can provide an optical disc recording method and optical disc recording apparatus capable of achieving satisfactory recording quality.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an exemplary optical disc recording and reproducing apparatus according to the present invention;

FIG. 2 is a block diagram showing an exemplary data reproducing circuit of FIG. 1;

FIG. 3 is a block diagram showing an exemplary strategy generating circuit of FIG. 1;

FIGS. 4A-4E are charts showing recording power settings;

FIG. 5 is a diagram showing a strategy of an embodiment 1 according to the present invention;

FIG. 6A is a diagram showing the temperature of a recording film and the state of the recording film;

FIG. 6B is a diagram showing a relationship with a recording pulse that causes a change in the temperature;

FIG. 7 is a diagram showing a recording power margin that illustrates the effect of the present invention;

FIG. 8 is a diagram showing a strategy of an embodiment 2 according to the present invention;

FIG. 9 is a diagram showing a logical unit of a BD;

FIG. 10 is an exemplary flow chart of the present invention;

FIG. 11 is a diagram showing an exemplary conventional multi-pulse type write strategy; and

FIG. 12 is a diagram showing an exemplary conventional castle type write strategy.

### DETAILED DESCRIPTION OF THE EMBODIMENTS

Embodiments of the present invention will be described below with reference to drawings.

### Embodiment 1

In the present embodiment, an example of an optical disc apparatus will be described in which power is changed according to the length of a mark to be recorded in a multi-pulse type strategy.

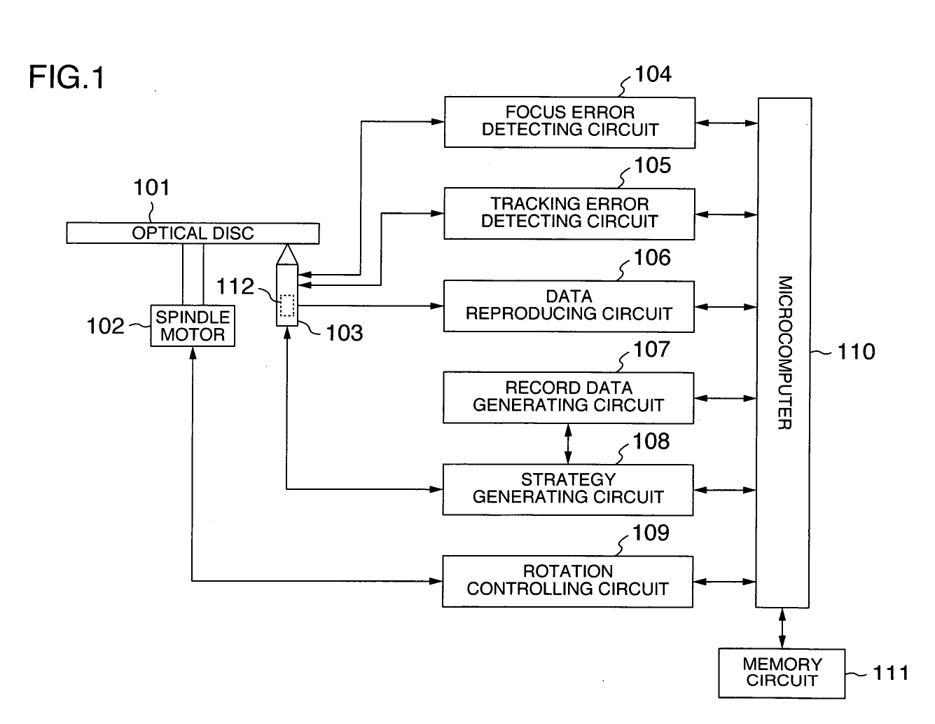

FIG. 1 is an exemplary block diagram of an optical disc recording and reproducing apparatus. In FIG. 1, 101 is an optical disc, 102 is a spindle motor, and 103 is an optical pickup. The optical pickup comprises a semiconductor laser, a lens group, a photodetector, a temperature sensor and the like. For the sake of simplicity, only the temperature sensor 112 is shown, with other components constituting the optical pickup being omitted in FIG. 1. It should be noted that, in order to make description more specific, the description is made on the assumption that the optical disc is a BD-RE.

First, a rotation speed, a radius position and the like are specified by a rotation controlling circuit 109, and the optical disc 101 is rotated at a desired rotation speed. A focus error signal and a tracking error signal are detected by the optical pickup 103. The focus error signal is a signal for position-controlling the incident direction of light. Control is performed by a focus error signal detecting circuit 104 such that a light spot is always condensed on the optical disc 101. The tracking error signal is a signal for causing the light spot to follow a track groove on the optical disc 101, and performs position control in the direction perpendicular to the track groove. A data reproducing circuit 106 reads information on the optical disc, and reads user data from an information signal on the optical disc. The BD-RE is a disc having information on a mark edge thereof. In the BD-RE, information is recorded by irradiating a recording power to transform a recording film and to change the reflectivity of the disc. A recorded part is referred to as a normal mark (record mark), while an area where little change is seen in the reflectivity between the marks is referred to as a space. In other words, spaces before and after each edge of the mark formed with a record are information signals.

During recording, at a record data generating circuit 107, data to be recorded is subjected to information modification that is intended for recording user data on the optical disc, and at a strategy generating circuit 108, strategy is generated.

The foregoing operations of the optical recording and reproducing apparatus are controlled together by a microcomputer 110, and information for use in the control is stored in a memory 111.

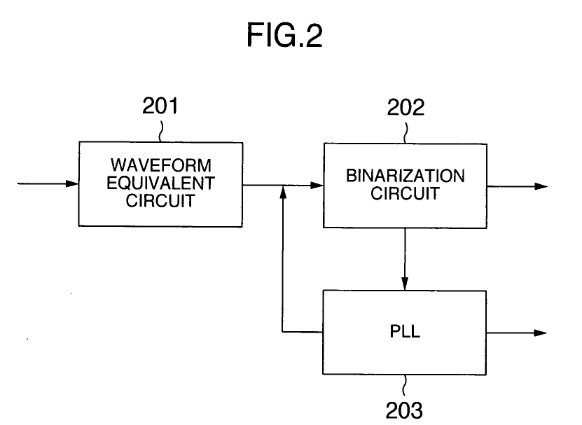

FIG. 2 shows the detail of the data reproducing circuit 106. A data signal is extracted from the optical pickup 103 as a harmonic signal (data signal) which is converted from light to electricity. The extracted harmonic signal is amplified at a waveform equalization circuit 201 such that an optimum signal is obtained at a subsequent signal processing circuit. Binarization is performed at a binarization circuit 202 with a certain signal level as a reference. Thus, information on recorded marks and spaces is obtained. An automatic adjustment is made such that the signal level for binarization becomes an average value of the data signal.

A reference clock is generated at a PLL (phase lock loop) 203 from the information signal obtained at the binarization circuit 202.

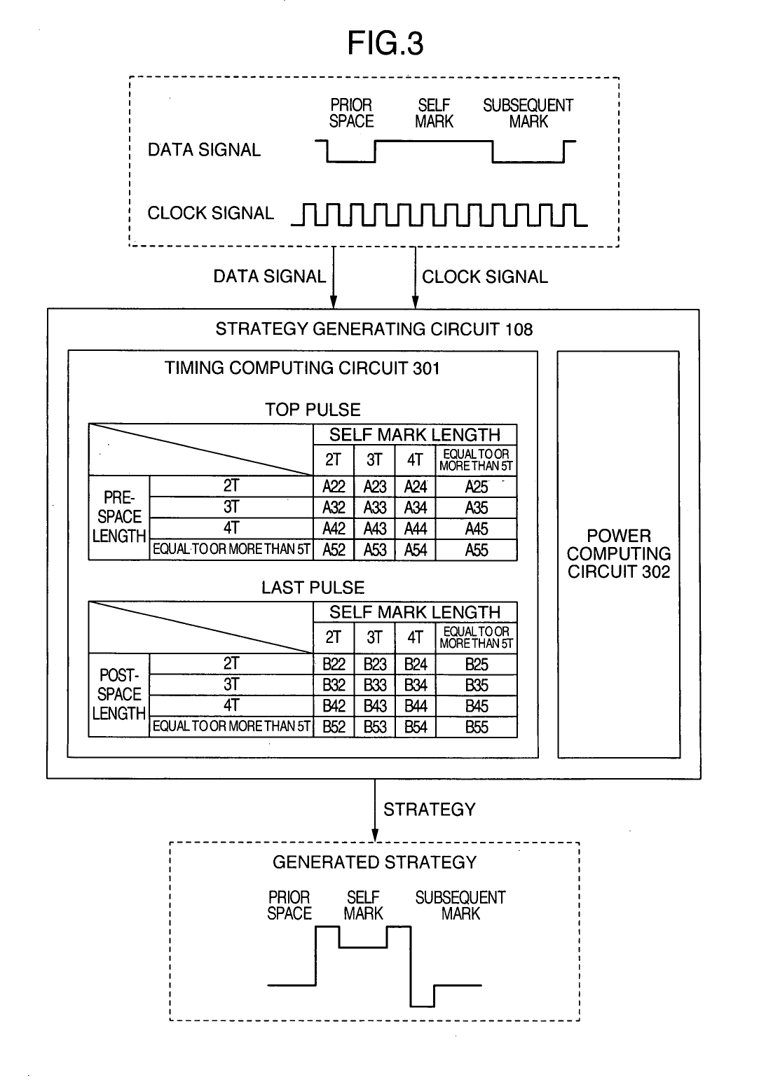

FIG. 3 is a magnified example of the strategy generating circuit 108. The strategy generation of the present embodiment will be described with reference to FIG. 3. The strategy generating circuit 108 generates a strategy using two signals of a data signal for recording purposes and a clock signal, which are generated at the record data generating circuit 107, as an input signal. The strategy generating circuit 108 comprises a timing computing circuit 301 for determining the timing on the time axis of the strategy, such as a rise position, a fall position and width; and a power computing circuit 302 for determining the power of the top pulse and last pulse.

First, the timing computing circuit 301 will be described. The timing computing circuit 301 determines the rise position, fall position and the like of the top pulse and last pulse according to a combination of the length of a self mark to be recorded, and the length of a prior space, located before the self mark, and the length of a subsequent space, located after the self mark. The reason why the determination is conducted in this manner according to the lengths of the spaces prior to and subsequent to the self mark in addition to the length of the self mark to be recorded is because thermal interference cannot be avoided between the front mark and back mark to be recorded as the mark becomes increasingly shorter.

An exemplary method of determining the rise position and width of the top pulse that is performed by the timing computing circuit 301 will be described below. As shown in a block of the timing computing circuit 301, in an example of a combination of the self mark length and prior and subsequent space lengths, 4 parameters of 2T, 3T, 4T and 5T (T indicates a reference clock) are used for all the self mark length and the prior and subsequent space lengths, thus a total of 16 (4×4) parameters being used. Specifically, when the self length is 2T and the prior space length is also 2T, “A22” is used as a start position parameter of the top pulse. The “A22” represents a deviation from the reference clock on the time axis. Also for the width of the top pulse, 16 parameters (4×4) are used, which are not shown for the sake of simplicity, and the width is determined according to the combination of the self mark length and prior space length. The fall position and width for the last pulse is also determined in the same manner as the top pulse.

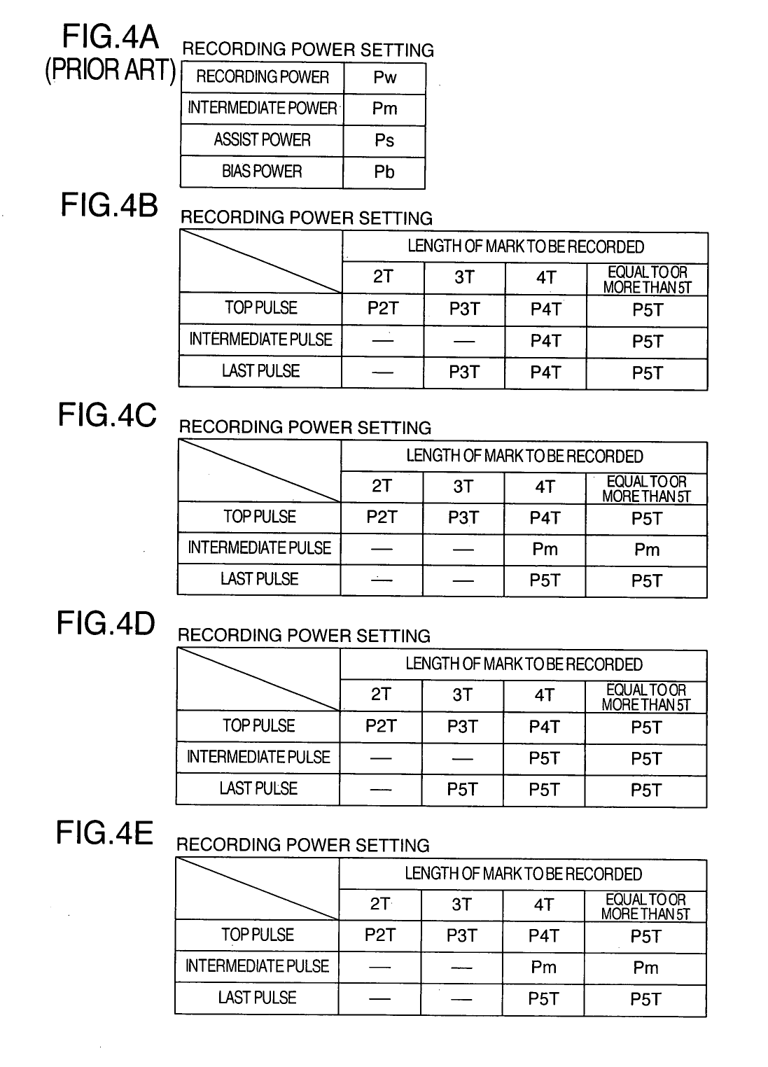

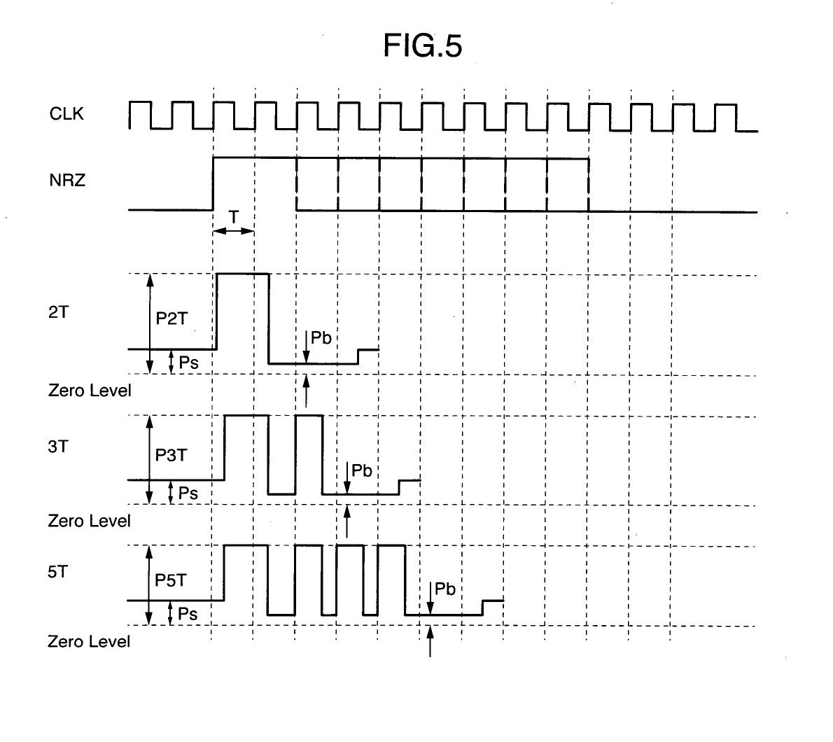

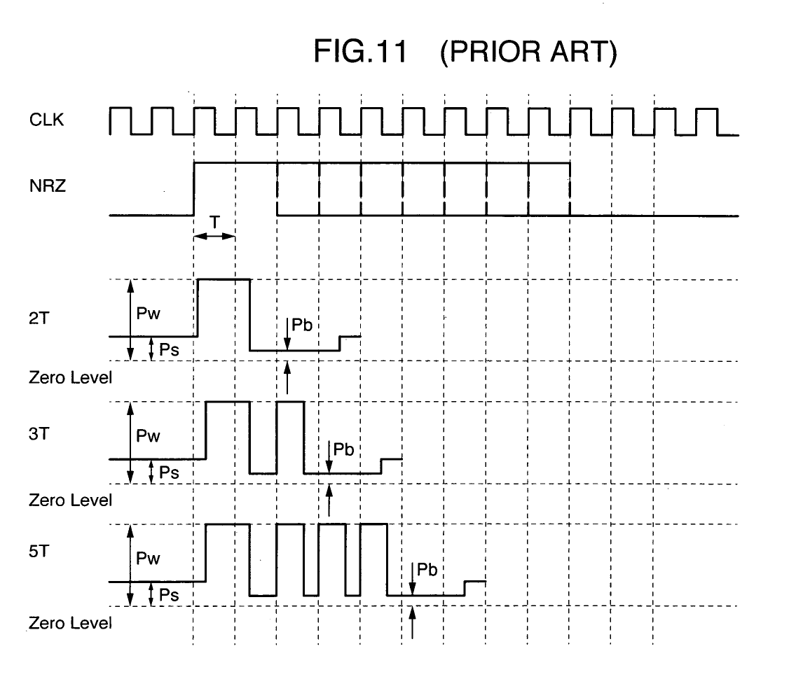

Next, the power computing circuit 302 will be described. The power computing circuit 302 basically determines the power of the top pulse, last pulse and intermediate pulse according to the self mark length. FIGS. 4A-4E show an example of power settings according to the self mark length, and FIG. 4B shows a power setting example in the present embodiment, while FIG. 4A shows a conventional example. FIG. 5 shows a strategy of the present embodiment which is determined using the parameters of FIG. 4B. FIG. 11 shows a strategy using the parameters of FIG. 4A. It should be noted, however, that an intermediate power Pm in FIG. 4A is not used in FIG. 11, because it is a parameter for use in the castle type strategy.

As is known from FIGS. 4A and 4B, FIG. 5, FIG. 11, while power remains constant even if the self mark length changes in the conventional embodiment, the power is changed according to the self mark length in the present embodiment like the following way. For example, if the self mark length is 2T, then the power for the top pulse is P2T, or if the self mark length is 3T, then the power for the top pulse is P3T in the present embodiment. Here, the power (P2T-P4T) for a short mark in FIG. 4B and FIG. 5 is set to higher than the power (P5T) for a long mark. Moreover, the shorter the mark length is, the mark is set to the higher power. This is because the use of higher power facilitates a rise in temperature of the recording film, even if laser irradiation time is short. In addition, when the length of the self mark is 5T or more (long mark), each power of the top pulse, intermediate pulse and last pulse is set to a constant value. This is because, since a long mark would enable a certain period of time of laser irradiation to be secured, a desired recording can be made without setting power as high as that used for the short mark.

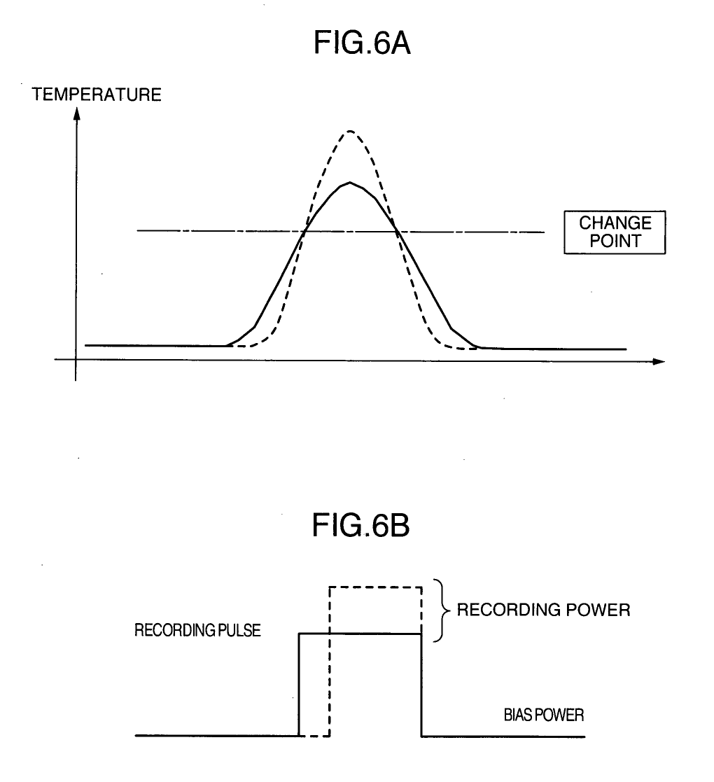

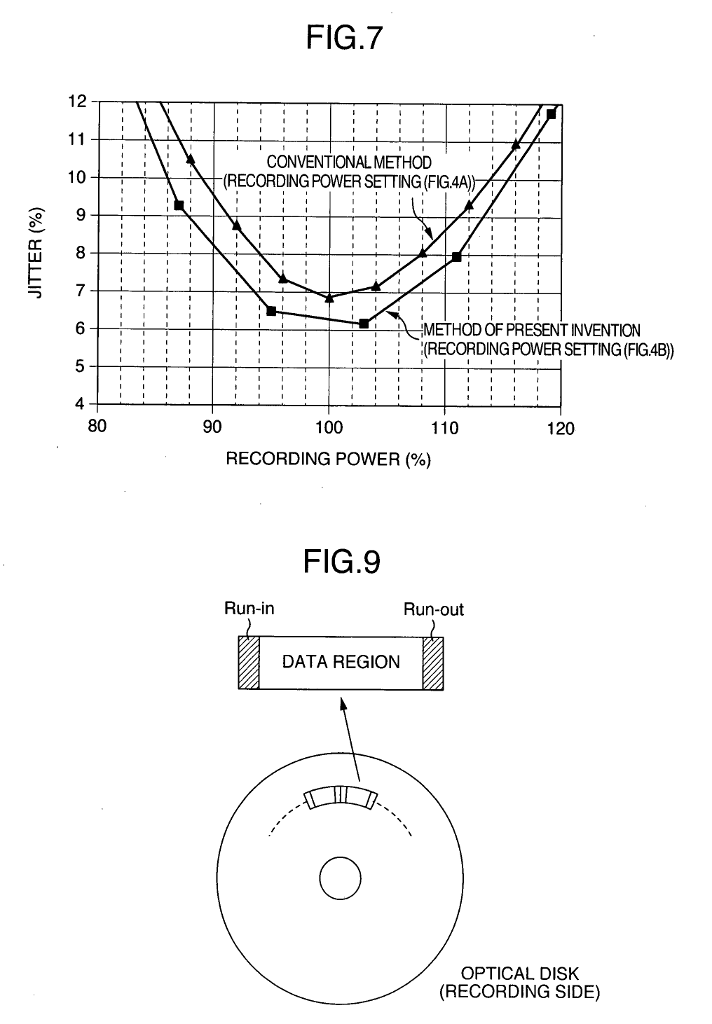

Now, the reason why P2T, P3T and P4T are each made higher than P5T in this manner is described with reference to FIGS. 6A and 6B. FIG. 6A shows the temperature of a recording film and state of the recording film. FIG. 6B shows a relation with a recording pulse which causes a change in temperature. When a recording pulse of the same energy is applied, a higher recording power would enable a recording film to reach faster a temperature, a changing point, at which the recording film changes. Therefore, it is possible to facilitate the thermal change of the recording film by setting the higher record power for the shorter mark. Furthermore, it becomes possible to prevent the deterioration of recording quality due to an insufficient thermal change during the formation of the short mark, which has been a problem in the conventional technology.

FIG. 7 shows the result of the comparison of recording power margin between the recording power setting of FIG. 4A and recording power setting of FIG. 4B. The recording power margin is a value indicating how much margin there is in the recording power for achieving certain recording quality when the timing condition of the strategy is set to constant and the recording power condition is changed. In FIG. 7, a lateral axis indicates the recording power, and an optimum recording power (recording power obtained by OPC) is assumed to be 100%. The vertical axis is an indicator referred to as a jitter, which is a value indicating a phase difference between a binarized signal and a clock during reproduction based on a reference clock signal. It can be seen that the smaller the jitter value is, the better the recording quality is, and that the larger the jitter value is, the worse the recording quality is.

When it is required to check the jitter, for example, to 8% or lower, the recording power has to be between about 94% to about 108% relative to the optimum recording power in the recording power setting of FIG. 4A. In contrast, the recording power just has to be about 91% to about 111% in the recording power setting of FIG. 4B. In this manner, the recording power setting of FIG. 4B has a larger margin for securing certain recording quality than the recording power setting of FIG. 4A, resulting in securing of a commercial production capacity margin during commercial production. The result shows that present invention is capable of minimizing the deterioration of recording performance due to recording power deviation, and of achieving a stable recording performance.

The structure of the present embodiment enables faster and higher density recording as compared with the conventional multi-pulse type strategy as shown in FIG. 11.

In the case of a rewritable type optical disc such as the BD-RE, which is shown in the present embodiment as a specific example, information that is once recorded is erased if a given high recording power is inputted unlike in the case of a write once type optical disc such as a BD-R. However, the information is not erased in the multi-pulse type strategy, such as the one of the present embodiment, in which an intermediate power is lowered for each 1T up to the low power at an intermediate pulse. Thus, the multi-pulse type strategy will be readily applicable to the BD-RE or the like. In view of this point, the multi-pulse type strategy like the one described in the present embodiment is particularly effective in implementing the high-speed and high-density recording in the rewritable optical disc such as the BD-RE.

While the timing computing circuit 301 and power computing circuit 302 are structured separately as an example of the strategy generating circuit 108 of FIG. 3 in the present embodiment, there is no limitation thereto. They may be implemented in one single circuit, or in three or more circuits, as appropriate. The appropriate circuit structure may vary depending on the relation between other elements and circuits in the strategy generating circuit 108.

In order to shorten the time from the disc insertion until the start of recording, the foregoing timing determining parameters as well as power determining parameters may be used that are previously recorded in a management region or the like of the disc, or that are previously recorded in a memory or the like of the optical disc apparatus. Furthermore, in order to deal with unevenness or the like in the recording film caused by variations in the manufacturing of the optical disc, trial writing referred to as OPC (Optimum Power Control) may be performed in advance of actual recording, and thereafter the power determining parameters may be obtained. Additionally, the OPC or the like may be performed again during the actual writing according to environmental changes such as temperature changes around the pickup to reconfigure the timing determining parameters as well as power determining parameters.

### Embodiment 2

In the present embodiment, an optical disc apparatus will be described in which power is changed according to the length of a mark to be recorded in a castle type strategy. While the BD-RE is used as a specific example of the optical disc in the embodiment 1, description will be made using a BD-R as a specific example in the present embodiment.

The structure of the optical disc apparatus, strategy generating circuit and the like is the same as that of the embodiment 1. Furthermore, as is the case with the embodiment 1, the timing computing circuit 301 determines the timing of the rising position, falling position and width of the top pulse and last pulse according to the length of the self mark length and lengths of the spaces before and after the self mark.

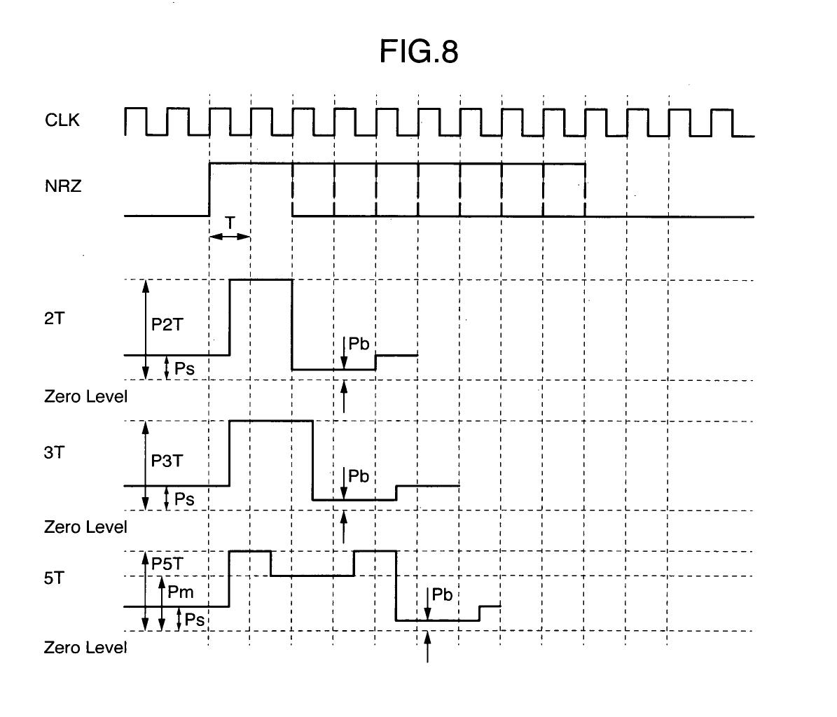

The strategy used in the present embodiment is a castle type. Therefore, unlike in the multi-pulse type, the intermediate pulse at the time when the length of the mark to be recorded is long takes a given intermediate power (Pm) without being lowered to an assist power (Ps) in one T cycle. Accordingly, the power computing circuit 302 determines the power of the top pulse, last pulse and intermediate pulse according to the length of self mark as shown in FIG. 4C. The strategy of the present embodiment in which the power is determined using the parameters of FIG. 4C is shown in FIG. 8, while the strategy using the parameters of FIG. 4A is shown in FIG. 12.

As is known from FIGS. 4A, 4C, 8 and 12, while even if the length of the self mark changes, the power remains constant in the conventional embodiment, the power is changed according to the length of the self mark in the present embodiment like the following: if the length of the self mark is 2T, then the power is P2T, or if the length of the self mark is 3T, then the power is P3T. Here, the power (P2T to P4T) for short mark in FIGS. 4C and 8 is configured to be higher than the power (P5T) for a long mark. Furthermore, a higher power is set to the shorter mark. This is due to the same reason as in the embodiment 1. In addition, if the length of the self mark is 5T or more (long mark), then the power for each of the top pulse and last pulse is set to a constant value of 5PT, with the power for the intermediate pulse being set to Pm. The reason why the constant value is set to the top pulse and last pulse for long mark is also due to the same reason as in the embodiment 1.

The structure of the present embodiment enables faster and higher density recording as compared with the embodiment 1 in which the multi-pulse type strategy is used and power is adjusted.

In the write once type optical disc such as the BD-R or the like, which is shown as a specific example in the present embodiment, information that is once recorded is not erased even if a given high recording power is inputted unlike in the rewritable type optical disc such as the BD-RE. Accordingly, information is not erased even in the castle type strategy, such as the one of the present embodiment, in which a high intermediate power is maintained at the intermediate pulse. Thus, the castle type strategy will also be readily applicable to the BD-R or the like. In view of this point, the castle type strategy such as the one in the present embodiment is particularly effective in implementing the high-speed and high-density recording in the write once type optical disc such as the BD-R.

In order to shorten the time from the disc insertion until the start of recording, the foregoing timing determining parameters as well as power determining parameters may be used that are previously recorded in a management region or the like of the disc, or that are previously recorded in a memory or the like of the optical disc apparatus as is the case with the embodiment 1. Furthermore, in order to deal with unevenness or the like in the recording film caused by variations in the manufacturing of the optical disc, trial writing referred to as OPC (Optimum Power Control) may be performed in advance of actual recording, and thereafter the power determining parameters may be obtained. Additionally, the OPC or the like may be performed again during the actual writing according to environmental changes such as temperature changes around the pickup to reconfigure the timing determining parameters as well as power determining parameters.

### Embodiment 3

In the present embodiment, a variation example of the embodiment 1 and embodiment 2 will be described.

In the embodiment 1, when the length of the mark to be recorded is 3T or more, the same power is set to all of the top pulse, intermediate pulse and last pulse. However, the thermal interference between adjacent marks takes place mostly at the timing of inputting the first recording power to the mark to be recorded and at the timing of interrupting last recording power to the mark to be recorded. Therefore, in the present embodiment, only the recording power for the top pulse is set according to the length of the self mark. Specific setting of the recording power is as described in FIG. 4D. When the length of the mark to be recorded is 3T or more, only the recording power for the top pulse is controlled according to the length of the self mark, with the recording power for the intermediate pulse and last pulse being all set to a constant value (e.g. P5T). This enables the achievement of high recording quality in the high-speed and high-density recording with a simpler control.

The above is true of the embodiment 2. As FIG. 4E shows, when the length of the mark to be recorded is 4T or more, only the recording power for the top pulse is controlled according to the length of the self mark, with that for last pulses being all set to a constant value (e.g. P5T). This enables the achievement of high recording quality in the high-speed and high-density recording with a simpler control.

### Embodiment 4

In the present embodiment, an example of an optical disc apparatus will be described that switches the recording power setting during recording on one optical disc.

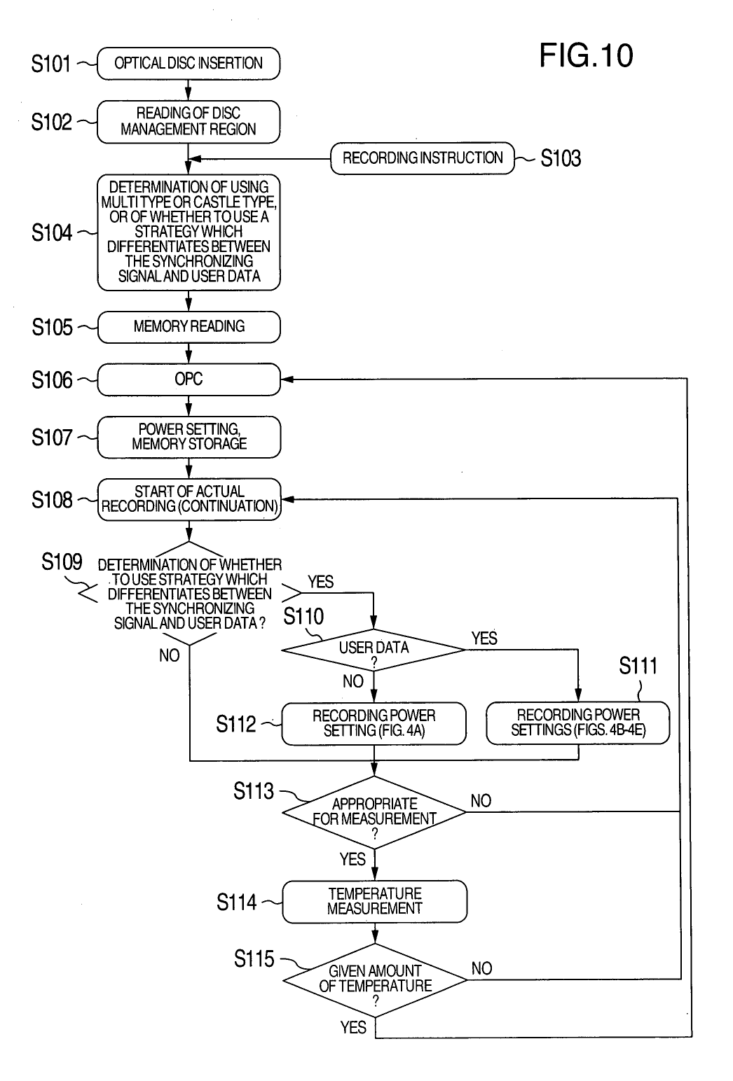

FIG. 9 shows a magnified diagram of one record unit in the BD. As is known from FIG. 9, the record unit is provided with regions referred to as Run-in and Run-out on the top and last part thereof, respectively, in such a manner that they sandwich the data region. A fixed data pattern, such as for example “3T, 3T, 2T, 2T, 5T, 5T,” is configured to be recorded repeatedly on these Run-in and Run-out, and it acts as a synchronizing signal during a reproducing operation.

In the embodiments 1 to 3, a certain recording power setting (FIGS. 4B, 4C, 4D and 4E) is used during recording on one optical disc without making distinction among the Run-in, Run-out and data region. However, in these recording power settings, the power that is used when recording a short mark with length 2T, 3T or the like is set to be higher than the power that is used when recording the long mark with length 5T or more. Therefore, if such a high power is used repeatedly, some semiconductor lasers that are used may suffer from problems of longevity and power consumption.

Accordingly, in the present embodiment, the conventional recording power setting of FIG. 4a and other recording power settings of FIGS. 4B-4E are properly used according to the recording on the Run-in and Run-out which are so-called synchronizing signals, and recording on other data regions.

Since the Run-in and Run-out act as synchronizing signals, user data is not recorded on these regions. In addition, the fixed data is recorded repeatedly on these regions as described in the above. Therefore, even if recording is performed on the Run-in and Run-out by power with somewhat high jitter, the record on those regions can properly be reproduced as synchronizing signals during reproduction.

Therefore, the recording power setting of FIG. 4A, in which the same recording power is set even if the length of the mark to be recorded changes, is used on the Run-in and Run-out regions. In addition, since user data is recorded on the data region, the recording power settings of FIGS. 4B-4E are used on the data region in order to maintain high recording quality even when the high-speed and high-density recording is performed.

This structure enables the reduction of load on the semiconductor laser and reduction of power consumption, and simultaneously enables the maintenance of a given level of recording quality in the high-speed and high-density recording.

A determination on whether to change the strategy according to the recording on the Run-in and Run-out and recording on other data regions may be made at drive initialization as in the present embodiment. Alternatively, it may be made according to users' instructions.

Also in the present embodiment, in order to shorten the time from the disc insertion until the start of recording, the foregoing timing determining parameters as well as power determining parameters may be used that are previously recorded in a management region or the like of the disc, or that are previously recorded in a memory or the like of the optical disc apparatus. Furthermore, in order to deal with unevenness or the like in the recording film caused by variations in the manufacturing of the optical disc, trial writing referred to as OPC (Optimum Power Control) may be performed in advance of the actual recording, and thereafter the power determining parameters may be obtained. Additionally, the OPC or the like may be performed again during the actual writing according to environmental changes such as temperature changes around the pickup to reconfigure the timing determining parameters as well as power determining parameters.

### Embodiment 5

In the present embodiment, an example of a flow chart from the insertion of an optical disc until the actual recording of user data in the optical disc apparatus described in the embodiments 1-4 will be described.

FIG. 10 shows the example of the flow chart of the present embodiment.

An optical disc is inserted at S101. Then, information regarding the kind of the optical disc (e.g. BD-R, Bd-RE or the like) and a parameter such as a recording power or the like which is previously recorded on the optical disc is read from a management region of the optical disc at S102. A record instruction is sent from the host at S103. Then, a determination is made at S104 on which one of the multi-pulse type and castle type strategy is to be used, and on whether to use a strategy which differentiates between the synchronizing signal and user data shown in embodiment 4 according to the kind of the optical disc. The Parameter such as the recording power or the like stored in a memory of the optical disc is read at S105. OPC is performed in advance of actual recording at S106. the parameter read at S102 may be used, or the parameter read at S105 may be used as the initial parameter of the recording power at the time when the OPC is performed. If an appropriate power is obtained at the OPC, it is stored in the memory of the optical disc at S107. Then, the actual recording is started at S108. In the actual recording, when a determination is made at S104 to use the strategy which differentiates between the synchronizing signal and user data, the process goes to S110. At S110, when the data to be recorded is user data, the process goes to S111 to perform recording with user data recording power (FIGS. 4B-4E), and thereafter goes to S113. When the data to be recorded is the synchronizing signal at S110, the process goes to S112 to perform recording with synchronizing signal recording power (FIG. 4A or the like), and thereafter goes to S113. When a determination is made at S104 not to use the strategy which differentiates between the synchronizing signal and user data, the process goes from S109 to S113. Then, the process goes from S113 to S114 at an appropriate timing to measure the ambient temperature of the pickup or the like. The ambient temperature is measured at S114, and then it is determined whether there is a given amount or more of ambient temperature at S115. When there is the given amount or more of temperature, the process returns to S106 where the OPC is performed again. When there is not the given amount or more of temperature, the process returns to S108 to continue the actual recording. When it is determined that the timing is not appropriate for measurement at S113, the process returns to S107 to continue the actual recording.

The foregoing appropriate timing includes when an instruction is given from the user periodically or the like.

As described in the above, it is possible to implement the optical disc recording method for obtaining satisfactory recording quality also in the high-speed and high-density recording.

It should be noted that FIG. 10 is just an example, and various other examples may be used as appropriate that would be capable of implementing the objects of the present invention, including an example in which S112 to S114 are omitted when the ambient temperature is not measured in order to speed up the recording.

While the foregoing embodiments 1 to 5 have been described by taking the BD-R and BD-RE as a specific example of the kind of the optical disc, the present invention is not limitative to the same. Both the multi-pulse type strategy and castle type strategy are applicable to both the BD-R (write once type) optical disc and BD-RE (rewritable type) optical disc.

It should be further understood by those skilled in the art that although the foregoing description has been made on embodiments of the invention, the invention is not limited thereto and various changes and modifications may be made without departing from the spirit of the invention and the scope of the appended claims.

1. An optical disc apparatus for forming a spot to record information on an optical disc, comprising:
a light emitting part for emitting a laser beam;
an emission waveform generating part for generating the emission waveform of said light emitting part; and
a control part for controlling said emission waveform generating part,
wherein said control part controls said emission waveform generating part such that it changes the height of the emission pulse of said emission waveform according to the length of said mark.

2. The optical disc apparatus according to claim 1, wherein:
said control part makes the height of said emission pulse higher as the length of said mark becomes shorter.

3. The optical disc apparatus according to claim 2, wherein: said control part makes the height of the emission pulse which is used when the length of said mark is 4T or less (T is a reference clock) higher than the height of the emission pulse which is used when the length of the mark is 5T or more.

4. The optical disc apparatus according to claim 3, wherein:
said emission waveform has a plurality of pulses when forming one mark.

5. The optical disc apparatus according to claim 4, wherein said plurality of pulses comprise a top pulse, an intermediate pulse and a last pulse, and
said control part controls said emission waveform generating part such that it changes only the height of the emission pulse of said top pulse according to the length of said mark.

6. The optical disc apparatus according to claim 1, comprising:
a temperature measuring part for measuring the temperature around the said light emitting part,
wherein said control part controls said emission waveform generating part such that it changes the height of said emission pulse according to said temperature.

7. An optical disc apparatus for forming a spot to record information comprised of a synchronizing signal and user data on an optical disc, comprising:
a light emitting part for emitting a laser beam;
an emission waveform generating part for generating the emission waveform of said light emitting part; and
a control part for controlling said emission waveform generating part,
wherein said control part controls said waveform generating part in such a way that:
recording is performed with a first emission power when the length of said mark to be recorded is a first length in one period of the periods for recording said synchronizing signal and for recording user data;
recording is performed with a second emission power different from said first emission power when the length of the mark to be recorded is the first length in the other period of the periods for recording said synchronizing signal and for recording user data; and
said first emission power is changed according to the length of said mark.

8. An optical disc recording method for emitting a laser beam from a light emitting part to form a spot and to record information on the optical disc, wherein:
the height of the emission pulse of said laser beam emission waveform is changed according to the length of said mark.

9. The optical disc recording method according to claim 8, wherein;
the height of said emission pulse is made higher as the length of said mark becomes shorter.

10. The optical disc recording method according to claim 9, wherein:
the height of the emission pulse which is used when the length of said mark is 4T or less (T is a reference clock) is made higher than that of the emission pulse which is used when the mark length is 5T or more.

11. The optical disc recording method according to claim 10, wherein:
said emission wavelength has a plurality of pulses when forming one pulse.

12. The optical recording method according to claim 11, wherein:
said plurality of pulses each comprises:
a top pulse;
an intermediate pulse; and
a last pulse, and
wherein only the height of the emission pulse of said top pulse is changed according to the temperature around said light emitting part.

13. The optical disc recording method according to claim 8, wherein:
the height of said emission pulse is changed according to said temperature around the light emitting part.

14. An optical disc recording method for emitting a laser beam from a light emitting part to form a mark and record information comprising a synchronizing signal and user data, wherein:
recording is performed with a first emission power when the length of said mark to be recorded is a first length in one period of the periods for recording said synchronizing signal and for recording user data;
recording is performed with a second emission power different from said first emission power when the length of said mark to be recorded is the first length in the other period of the periods for recording said synchronizing signal and for recording user data; and
said first emission power is changed according to the length of said mark.
